(19) United States
(12) Patent Application Publication
(10) Pub. No.: US 2009/0203956 A1
(43) Pub. Date: Aug. 13, 2009

(54) NEONATE OR INFANT PULSATING WEAR

(76) Inventor: Sayed Nour, Puteaux (FR)

Correspondence Address: YOUNG & THOMPSON, 209 Madison Street, Suite 500, ALEXANDRIA, VA, 22314, US

(21) Appl. No.: 12/306,402

(22) PCT Filed: Nov. 15, 2006
(86) PCT No.: PCT/CN06/03077

§ 371 Date: Dec. 23, 2008

(30) Foreign Application Priority Data
Jun. 23, 2006 (CN) 200620122203.9

(51) Int. Cl. A61H 31/00

(52) U.S. Cl. 600/16; 601/152

(57) ABSTRACT

A neonate or infant pulsating wear to obtain the pulse is disclosed, which comprise a multilayer structure. The structure comprises an elastic inner layer contacted with the body of the infant, an outer layer isolated with the body of the infant, and a middle layer between the inner layer and the outer layer. The middle layer contains a pulsant cyclic liquid and the outer layer is harder than the inner layer.

### FIELD OF THE INVENTION

The present invention relates to a medical device, and more particularly, the invention relates to a pulsating wear for neonate and infant to obtain a pulsatile flow.

### BACKGROUND OF THE INVENTION

When neonatal infant or child has a low Cardiac Output (CO) status, with hemodynamic disturbances, due to decreased Preload, a pulsatile therapeutic method will be very helpful to recover the hemodynamics to its normal values by increasing venous return. The recovery operation may be performed by a device that can press the muscle of the child in interim consistent with the normal pulsation of the child.

Various devices are available in market. One of these devices is a pulsating wear. When in pulsation recovery operation, the pulsating wear is put on the infant or child. By regularly pressing the suit, the particular regions of the suit generate suitable impact on muscle of the infant or child, thus gradually recovering hemdodynamics to its normal values.

However, conventional pulsating wear is unsafe to the neonatal infant of child, since infant or child is normally in a weak physical condition after their birth, and conventional pulsating wear works irregularly. The irregularity makes the operation work improperly and thus dangerous to the child.

Thus, there is a need for an improved pulsating wear for neonate and infant that does not suffer from the above-mentioned drawbacks.

### SUMMARY OF THE INVENTION

Main object of the present invention is to provide a pulsating wear for neonate and infant, which is safe to neonatal infant and child.

To obtain the above object, a pulsating wear for neonate and infant to obtain a pulsatile flow is provided, which has a multilayer structure that includes an inner elastic layer contacting the body, an outer layer isolated from the body and a middle layer sandwiched between the inner elastic layer and the outer layer. The middle layer has pulsant fluid filled therein. The outer layer is harder than the inner layer.

The outer layer of the multilayer structure is connected to a gas connector, and via the gas connector, an external gas supply may drive the pulsant fluid in the middle layer to produce suitable compressive force to infant or child. In addition, the outer layer is non flexible and harder than the inner elastic layer, so compressive force is mainly applied to the body. In addition, at least one relaxing hole is defined in the suit for relaxing body of the neonatal. For sake of safety, the outer layer may have at least one security air release valve for deflate the suit.

In an embodiment, the pulsating wear is a pulsatile trouser comprised of a waist belt, a trouser crotch portion connected to the waist belt, and a pair of trouser legs connected to the trouser crotch portion. At least one of the waist belt, trouser crotch portion and trouser legs has said multilayer structure.

In another embodiment, the pulsating wear is a pulsatile jacket comprised of a back-chest portion to cover the back and chest of the neonatal, a belt to surround the waist of the neonatal and a pair of sleeve portions to surround the arms of the neonatal. At least one of the back-chest portion, belt and sleeve portions has said multilayer structure. The back-chest portion, the belt and the pair of sleeve portions are connected together. At least one of the back-chest portion and belt portions has a non pulsed region formed thereon.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is a plan view of a pulsatile jacket for neonate and infant according to an embodiment of the invention;

FIG. 2 is a cross-sectional view illustrating a multilayer structure of the pulsatile jacket of FIG. 1;

FIG. 3 is a plan view of a pulsatile jacket driven by an intra aortic balloon pump or an EECP machine;

FIG. 4 is a plan view of a pulsatile trouser for neonate and infant according to an embodiment of the invention;

FIG. 5 is a cross-sectional view illustrating a multilayer structure of the pulsatile trouser of FIG. 4; and

FIG. 6 is a plan view of a pulsatile trouser driven by an intra aortic balloon pump or an EECP.

### DETAILED DESCRIPTION OF ILLUSTRATED EMBODIMENTS

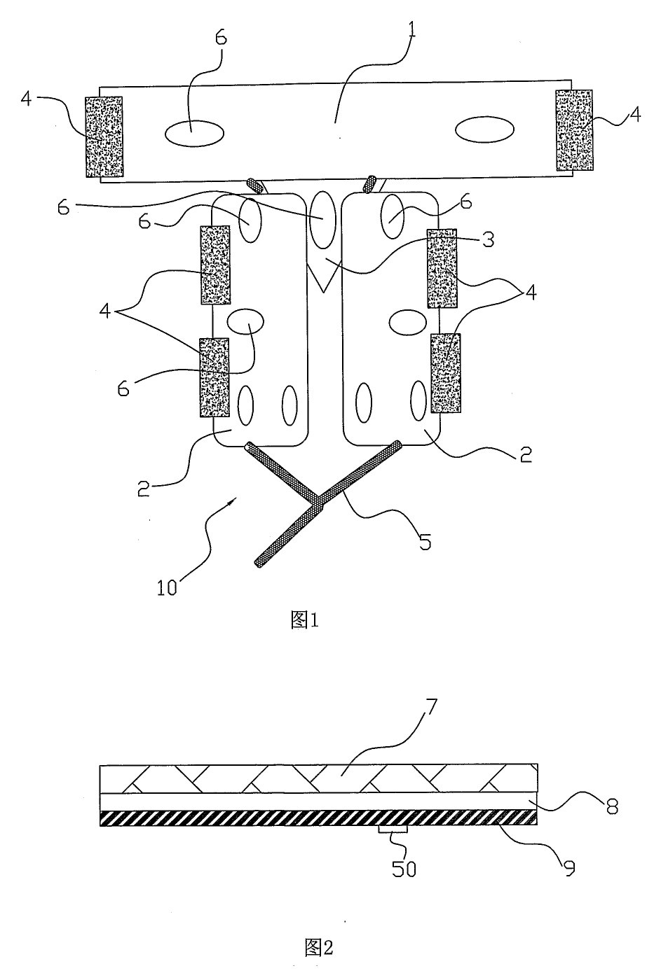

The invention provides a safe and easy-to-use pulsating wear for neonate and infant. The suit may be a trouser, jacket or any other suitable form of suit which can be put on a child and generate proper pulsed flow. Referring to FIGS. 1-3, according to an embodiment of the invention, a pulsatile trouser 10 is provided for neonate and infant to obtain a pulsatile flow. The pulsatile trouser 10 comprises: a waist belt 1, a trouser crotch portion 3 connected to the waist belt 1 and a pair of trouser legs 2 connected at two sides of the trouser crotch portion 3.

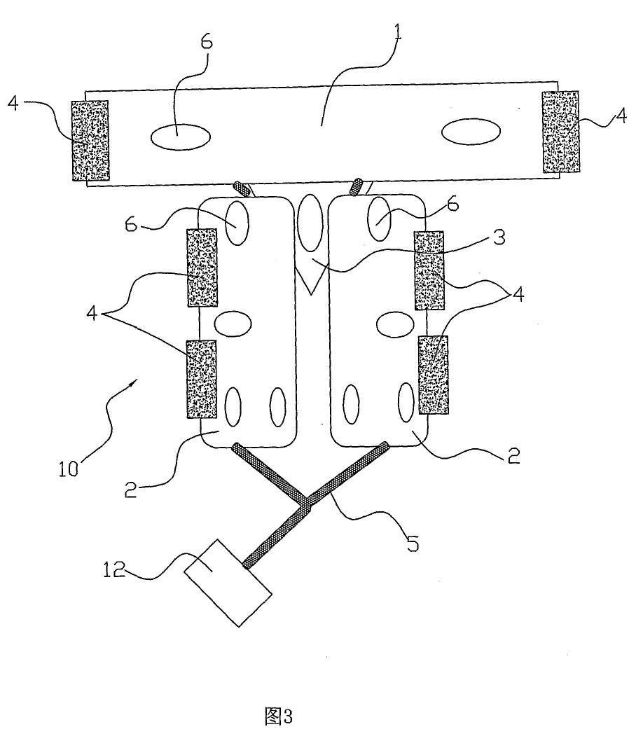

At least one of the waist belt 1, trouser crotch portion 3 and trouser legs 2 has a multilayer structure. As shown in FIG. 2, the multilayer structure includes an inner elastic layer 7 that touches the body of an infant or a child, an outer layer 9 that is isolated from the body and a middle layer 8 sandwiched between the inner elastic layer 7 and the outer layer 9. The middle layer 8 has trapped fluid circulation provided therein, and the outer layer 9 is non flexible and harder than the inner elastic layer 7.

When a pulsation recovery operation is performed to an infant or a child, the pulsatile trouser 10 is put on the infant or the child with its waist belt 1, trouser crotch portion 3 and trouser legs 2 covered to the corresponding positions of the infant or the child. More particularly, the waist belt 1 surrounds the waist of an infant, the trouser crotch portion 3 covers the perineal portion of the infant, and the trouser legs 2 surround two legs of the infant. At this time, the inner elastic layer 7 of the multilayer structure touches the skin of the infant or the child covered by the pulsatile trouser 10. Then, the trapped fluid circulation in the middle layer 8 is driven to circulate in the middle layer 8 and the circulated fluid regularly causes compressive force to the underlying wrapped part of the infant body. Since the outer layer 9 is nonflexible and harder than the inner elastic layer 7, the rhythmic compressive force is mainly applied to the lower limbs, gluteal muscles and abdomen of the infant body. Thus will reduce venous capacitance leading to better hemodynamic status.

In this embodiment, the trapped fluid circulation in the middle layer may be driven by an external gas supply such as an intra aortic balloon pump (IABP) 12 (see FIG. 3), an EECP machine, or an electric pulsation generation device for example high voltage pulsed direct current that utilizes two oppositely charged electrodes to produce suitable compressive force to the infant or child. As shown in FIGS. 1, 3, several gas connectors 5 may be attached to the pulsatile trouser for conveniently connecting the pulsatile trouser with an external device such as an IABP or an EECP. It is proved that the pulsatile trouser of the invention is safer than prior art.

In the embodiment, the fluid may have different viscosity, and the fluid may be any suitable liquid material such as normal saline or other gelatinous liquids.

In an embodiment, the inner elastic layer has a thickness of 2.5 mm, the middle layer has a thickness of 1.5 mm, and the outer layer has a thickness of 1.5 mm. These dimensions make the entire trouser work more ideally. Moreover, the inner elastic layer may be formed by any suitable material such as neoprene for providing good elasticity.

The pulsatile trouser of the invention may be secured to the infant by any suitable manner such as pairs of adhesive strips 4 attached on the trouser. In addition, for suitably reducing the pressure applied to the infant, relaxing holes may be formed on the pulsatile trouser. For example, the relaxing holes 6 may be formed on one or all of the waist belt at the middle to free the umbilical part, in the, trouser crotch portion and trouser legs. In this case, the relaxing hole 6 located in middle portion of the trouser crotch portion 3 is used to avoid any compressive forces applied to the genitalia of the infant also as an exit port for urinary catheter, rectal probe . . . , and the relaxing holes 6 located in the groin knees and malloelar related parts of the trouser.

In addition, preferably, the outer layer 9 of the trouser shown in above embodiment has at least one security air release valve 50 in each part of the trouser to prevent over inflation accident.

It is preferred that each component of the pulsatile trouser has its own inflation/deflation control security valve. This allows different pressure application according to different parts of the delicate pediatric body.

Furthermore, it is noted that partial or all of the components of the pulsatile trouser are reassembled easily together through adhesive strips or zippers for reducing difficulties for a baby especially for an operated baby to dress the trouser in a supine position. That is, when dressing the trouser, the presumed treated Baby will be positioned on the trouser previously openly prepared over his bed, before the trouser to be wrapped around the choosing body part easily & tightly.

The invention provides a pulsatile trouser which is of a non-invasive pulsatile Cardiac Assist device and which helps to eliminate immediate & long term hemodynamic disturbances for example problems related to increased stagnant venous capacitance and right ventricular (RV) failure especially for very young persons as well as adults.

Normally, since the RV blood supply is dependent on the preload ventricular diastolic filling, the RV blood supply is easily jeopardized by some situation in which the preload is decreased due to e.g. increased stagnant venous capacitance. Accordingly, the currently used therapeutic methods for RV failure are: increasing the preload by intravenous fluids as well as by enhancing the atrial kick (30% of cardiac output) using inotropic drugs, pace maker etc. Namely, conventional therapeutic methods increase RV diastolic volume and contractility by an indirect and non physiological way. More specifically, these conventional methods are targeting the cardiac pump but not the dysfunctional circuit system, most probably due to the stagnant increased venous capacitance, volume escape, endothelial dysfunction.

Comparatively, a new method performed by the pulsatile trouser of the invention is targeting the affected cardiovascular system as a whole in more physiological method by improving in the same time the cardiac pump as well as the endothelium function.

Moreover, beside advantageous in RV failure, the pulsatile trouser of the invention can also be used as a stimulating endothelium function device in cases of myocardial ischemia like IABP, EECP devices.

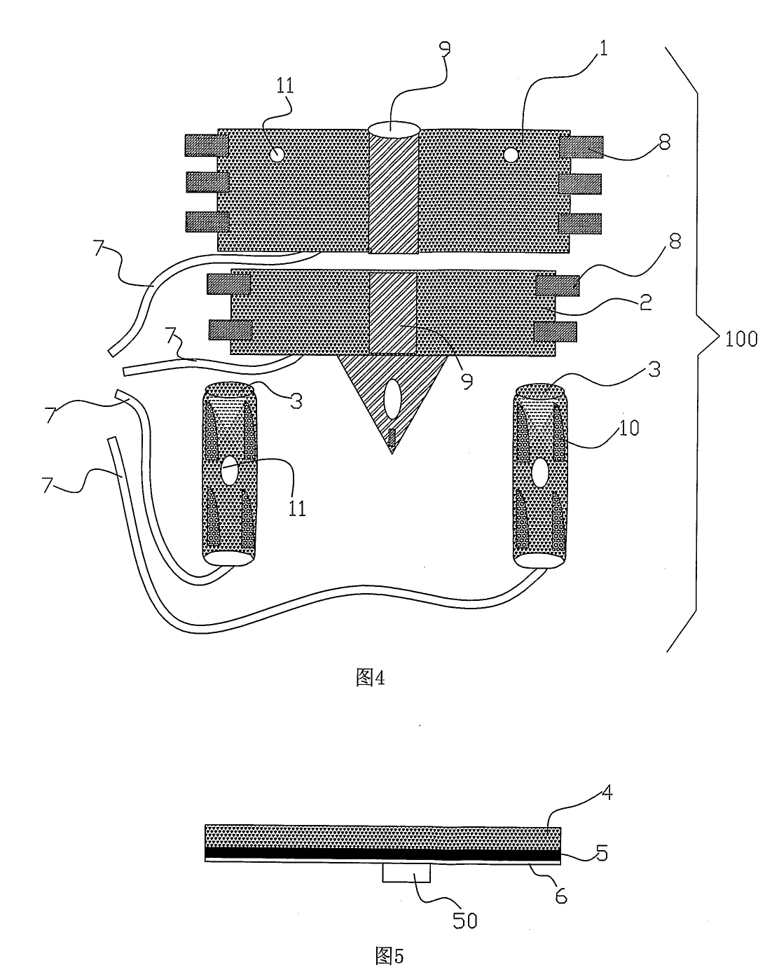

Referring to FIGS. 4-6, according to another embodiment of the invention, a pulsatile jacket 100 is provided for pediatric to obtain a pulsatile flow that can reduce the stagnant venous capacitance, in the supra-diaphragmatic area of the child body.

The pulsatile jacket 100 comprises: a back-chest portion 1 to cover the back and chest of an infant, a belt 2 to surround the waist of the infant and a pair of sleeve portions 3 to surround the arms of the infant.

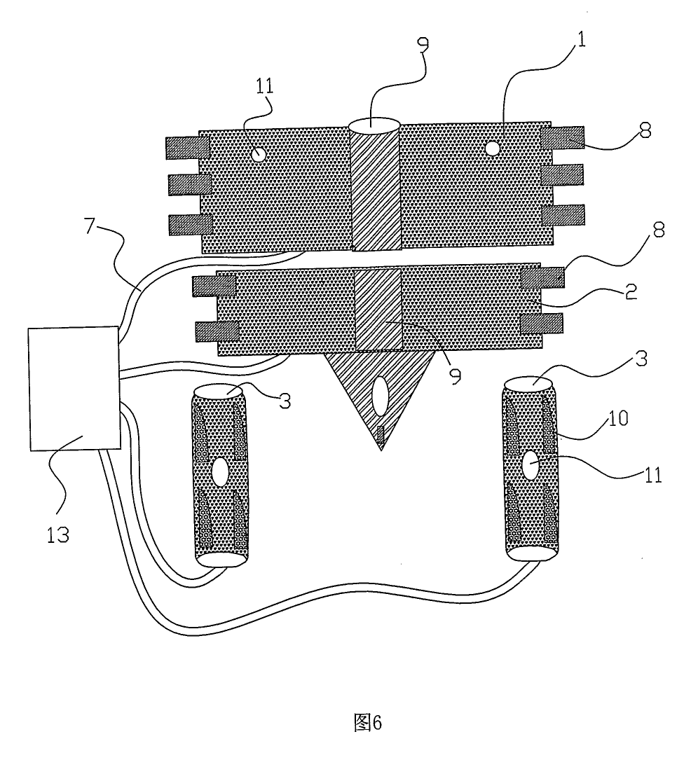

At least one of the back-chest portion 1, belt 2 and sleeve portions 3 has a multilayer structure. As shown in FIG. 5, the multilayer structure includes an inner layer 4 that touches the body of the infant, an outer layer 6 isolated from the body and a middle layer 5 sandwiched between the inner layer 4 and the outer layer 6, the middle layer 5 having pulsant fluid filled therein, the outer layer 6 being harder than the inner layer 4.

When a pulsation recovery operation is performed to an infant or a child, the pulsatile jacket 100 is put on the infant or the child with its back-chest portion 1, belt 2 and sleeve portions 3 covered to the corresponding positions of the infant or the child, i.e., back, chest, waist and arms of the infant. At this time, the inner layer 4 of the multilayer structure touches the muscles of the infant or the child covered by the pulsatile jacket 100. Then, the pulsant fluid filled in the middle layer 5 is driven to cause regular compressive force to the arms and thoracic wall muscles. Since the outer layer 6 is harder than the inner layer 4, the compressive force is mainly applied to the infant upper limbs and chest, in total rhythmic synchronization with the respiratory movements. Thus will increase the Positive-negative respiratory pressure gradient, bringing back more venous return, leading to hemodynamic recovery to its normal values.

In this embodiment, the pulsant fluid in the middle layer may be driven by an external gas supply such as an intra aortic balloon pump (IABP) 13 (see FIG. 6), an EECP, or an electric pulsation generation device for example high voltage pulsed direct current that utilizes two oppositely charged electrodes to produce suitable compressive force to the infant or child. As shown in FIGS. 4, 6, several gas connectors 7 may be attached with an external device such as an IABP, or an EECP for conveniently driving the pulsant fluid in the middle layer 5. It is proved that the pulsatile jacket of the invention is safer than prior art.

In the embodiment, the fluid may have different viscosity, and the fluid may be any suitable liquid material such as normal saline or other gelatinous liquids.

In addition, in the embodiment, all the components of the pulsatile jacket of the invention are independent from each other, thus making the pulsatile jacket easy to put on; however, in other embodiment, the components may also be connected together by any suitable manner for example by adhesive strips or resilient clips.

The pulsatile jacket 100 of the invention may be secured to the infant by any suitable manner such as pairs of adhesive strips 8 (see FIG. 4) attached on the jacket 100. Preferably each sleeve portion has zippers 10 formed thereon to enable the sleeve portions surrounding arms of the infant more easily.

In addition, for suitably reducing the pressure applied to the infant, as well as for easy accesses for medical manipulations, relaxing holes 11 may be formed on the pulsatile jacket 100. For example, the relaxing holes 11 may be formed on one or all of the back-chest portion 1, belt 2 and sleeve portions 3. The relaxing holes 11 on the back-chest portion 1 are used as access for IV lines, ECG electrodes . . . , while the relaxing holes 11 on the sleeve portions 3 are used to relaxing the elbows of the infant.

In addition, for making operation safer, non pulsed region 9 may be formed on the back-chest portion or the Belt portions so that the pulsant fluid has no side effect on backbone of the infant.

Preferably, the outer layer 6 of the jacket shown in above embodiment has at least one security air release valve 50 in each part of the jacket to prevent over inflation accident which is dangerous to the baby.

It is preferred that each component of the jacket has its own inflation/deflation control security valve. This allows different pressure application according to different parts of the delicate pediatric body.

Furthermore, it is noted that partial or all of the components of the jacket are reassembled easily together through adhesive strips or zippers for reducing difficulties for a baby especially for an operated baby to dress the jacket in a supine position. That is, when dressing the jacket, the presumed treated baby will be positioned on the jacket previously openly prepared over his bed, before the jacket to be wrapped around the choosing body part easily & tightly. It is noted that the jacket of the invention can obtain similar disease eliminating effect as the trouser shown in the foregoing embodiment; accordingly, detailed description thereof is omitted here from so that not obscure the invention. In addition the jacket could be used as a respiratory physiotherapeutic Device.

Although in above embodiments the pulsating wear is comprised of a three-layered structure; however, it can also has other number of layers, for example one or two layers, as long as can provide pulsation to a child. In addition, the pulsating wear may also be used to improve hemodynamic of the child by increasing body temperature.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

1-10. (canceled)

11. A pulsating wear to obtain a pulsatile flow, wherein the pulsating wear has a multilayer structure that includes an inner elastic layer contacting the body, an outer layer isolated from the body and a middle layer sandwiched between the inner elastic layer and the outer layer, the middle layer having pulsant fluid filled therein, the outer layer being harder than the inner layer.

12. The pulsating wear according to claim 11, wherein the pulsating wear is a pulsatile trouser comprised of a waist belt, a trouser crotch portion connected to the waist belt, and a pair of trouser legs connected to the trouser crotch portion.

13. The pulsating wear according to claim 12, wherein at least one of the waist belt, trouser crotch portion and trouser legs has said multilayer structure.

14. The pulsating wear according to claim 11, wherein the third layer of the multilayer structure is connected to a gas connector.

15. The pulsating wear according to claim 11, wherein at least one relaxing hole is defined in the suit for relaxing body.

16. The pulsating wear according to claim 11, wherein the outer layer is non flexible and has a toughness larger than the inner elastic layer and the outer layer has at least one security air release valve.

17. The pulsating wear according to claim 11, wherein the pulsating wear is a pulsatile jacket comprised of a back-chest portion to cover the back and chest, a belt to surround the waist and a pair of sleeve portions to surround the arms.

18. The pulsating wear according to claim 17, wherein at least one of the back-chest portion, belt and sleeve portions has said multilayer structure.

19. The pulsating wear according to claim 17, wherein the back-chest portion, the belt and the pair of sleeve portions are connected together.

20. The pulsating wear according to claim 17, wherein at least one of the back-chest portion and belt portions has a non pulsed region formed thereon.

21. The pulsating wear according to claim 11, wherein the pulsating wear is adapted for very young persons.

22. The pulsating wear according to claim 11, wherein the pulsating wear is adapted for adults.

23. A multilayer structure including an inner elastic layer contacting the body, an outer layer isolated from the body and a middle layer sandwiched between the inner elastic layer and the outer layer, the middle layer having pulsant fluid filled therein, the outer layer being harder than the inner layer, wherein said multilayer structure.

24. Method for improving the cardiac pump and the endothelium function of a person comprising causing regular compressive forces to at least a part of the body of said person.
